(19) United States
(12) Patent Application Publication
(10) Pub. No.: US 2017/0101182 A1
(43) Pub. Date: Apr. 13, 2017

(54) Overhead Delivery System for Transporting Products

(71) Applicant: International Business Machines Corporation, Armonk, NY (US)

(72) Inventors: Austin B. Brown, Seoul (KR); Glenn R. Fisher, Austin, TX (US); Steven J. Gilman, New York, NY (US); Sean R. Lang, Lowell, MA (US)

(73) Assignee: INTERNATIONAL BUSINESS MACHINES CORPORATION, Armonk, NY (US)

(21) Appl. No.: 14/881,217

(22) Filed: Oct. 13, 2015

(51) Int. Cl. B64D 11/00; B65G 17/26; B65G 17/20

(52) U.S. Cl. CPC B64D 11/0007; B65G 17/20; B65G 17/26

(57) ABSTRACT

Embodiments relate to transport of products in a region. A delivery system is mounted to an overhead surface of a region, and at least one in communication with the delivery system is subject to movement along sections of the delivery system. The delivery system has a primary section extending through a length of the region, and a secondary section extending relatively perpendicular to the primary section. More specifically, the at least one container is subject to movement along at least first and second axes to transport a product for delivery to a destination. The first axis is parallel with the primary and secondary sections. The second axis is orthogonal to the first axis and the delivery system.

### BACKGROUND

The present invention relates to delivering and transporting products. More specifically, the invention relates to system and method for transporting products through use of an overhead delivery system.

It is recognized that commercial travel frequently includes consumption of food and/or beverage, and in limited circumstances, such as air travel, delivery in the form of food and/or beverage service. Depending on the size of the aircraft, one or more longitudinal aisles are provided that extend from the front of the aircraft to the rear of the aircraft. The flight attendants use the aisle(s) to serve food and/or beverage to the passengers. In large aircraft, the flight attendants frequently use carts, also referred to herein as beverage carts, to dispense the food and/or beverage. These carts are mobile and are positioned to move along the aisle.

Aisles in aircrafts are relatively narrow, and are configured with a width that is limited to a single passenger. In other words, two passengers cannot walk side-by-side in the aisle. The carts for the aircraft are configured to fit within the width of the aisle without contacting the seats. During use, the carts are moved along the aisle(s), and because of the limited space in the aisle configuration, the carts present an obstacle to passengers who may need or want to move from their seats and require a non-obstructed aisle. Passengers in a single-aisle aircraft are forced to wait for the cart to move through the aisle, or be moved in order to accommodate the passenger. At the same time, the aircraft is configured with a finite amount of space. Economic principles dictate that within a fixed space, maximizing seating in the aircraft yields greater profits to the associated airline.

### SUMMARY

The invention includes a system and method for transporting products in a region via an overhead delivery system.

The system and method employ a delivery system and at least one container in communication with the delivery system. The delivery system is mounted to an overhead surface of a region. There are two components to the delivery system, including a primary section extending through a length of the region from a front end of the surface to a back end of the surface, and a secondary section extending relatively perpendicular to the primary section. The at least one container is configured with two degrees of movement relative to the delivery system. The movement includes a first degree of movement along a first axis in communication with the delivery system and parallel with the primary and secondary sections. The second degree of movement is along a second axis that is orthogonal to the first axis and the delivery device. A product is transported through the container and along the mounted transport device. Specifically, the container is subject to movement via the at least first and second axes for delivery of the product to a destination.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments unless otherwise explicitly indicated.

FIG. 1 depicts a diagram illustrating a fuselage design in a commercial aircraft.

FIG. 2 depicts a diagram illustrating useable space within an interior area of a commercial aircraft.

FIG. 3 depicts a diagram illustrating a cross section view of a delivery mechanism in communication with the ceiling.

FIG. 4 depicts a diagram illustrating a structure of the rail extending through the aircraft interior.

FIG. 5 depicts a block diagram illustrating a cross section of the rail.

FIG. 6 depicts a perspective view illustrating the delivery system of FIG. 4.

FIG. 7 depicts a diagram illustrating stacking of multiple storage compartments along a rail mounted transport system.

FIG. 8 depicts a diagram illustrating stacking of multiple storage compartments along a rail mounted transport system.

FIG. 9 depicts a diagram illustrating mounting of multiple connectors to a rail.

FIG. 10 depicts a flow chart illustrating a process for utilizing the rail mount storage compartment(s).

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

The embodiments described herein will make reference to a fuselage design in a commercial aircraft. It is to be understood that a commercial aircraft is being used solely in an exemplary fashion, and it is to be appreciated that the embodiments described herein are not limited to a commercial aircraft context. Accordingly, the embodiments described herein may be applied within the context of any suitable region in a travel vehicle.

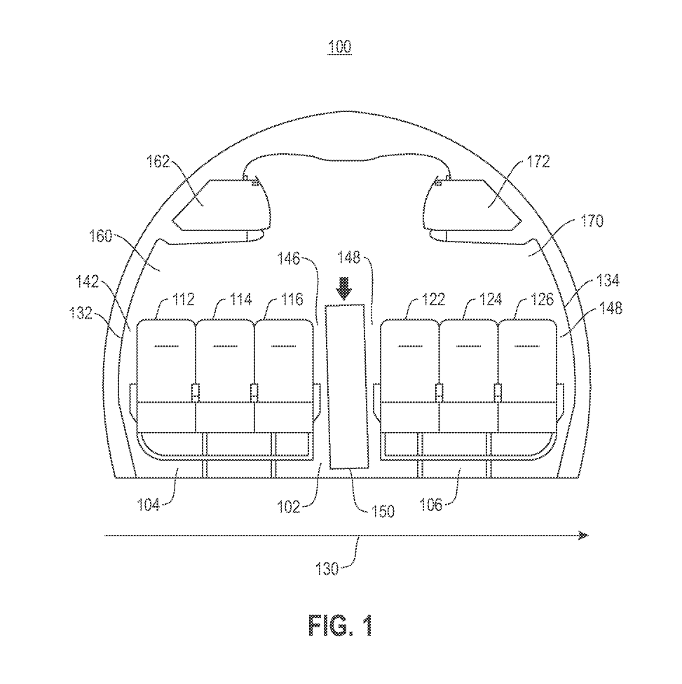

With reference to FIG. 1, a diagram (100) is provided depicting a fuselage design in a commercial aircraft. More specifically, the depiction pertains to a narrow bodied aircraft. It is understood that a wide body aircraft is generally configured with two parallel aisles, similarly configured to the single aisle embodiment. As shown, the interior of the aircraft includes an aisle (102) with two rows of seats (104) and (106) on either side of the aisle. Each row of seats (104) and (106) is shown with three individual seats to accommodate one adult passenger per seat. For example, row (104) is shown with seats (112), (114), and (116), and row (106) is shown with seats (122), (124), and (126). The width of the aircraft (130) is approximately 148 inches. Each individual seat has a width of approximately 17 inches. At the same time, a gap of a few inches is provided in several locations, including a space (142) between the seat (112) and the wall (132), a space (144) between seat (126) and the wall (134), and a gap is provided between the seats and the aisle (102), at (146) and (148). As shown, it is understood that the armrest of a seat adjacent to the aisle also utilizes some of the aisle space, although a minimal amount. This limited space in the aisle leaves one to consider where there is space available in the fuselage, such as space above the seats, including but not limited to space between clusters of seats (104) and (106), and around any overhead storage compartments.

There is a finite amount of useable space in the interior of the commercial aircraft. The useable space is referred to herein as the aisle (102), and also the area above the seats. As shown herein, a first overhead area (160) is defined as open space above the row (104) and a second overhead area (170) is defined as open space above the row (106). This useable space is also limited. Specifically, overhead storage compartments are shown at (162) and (172), respectively. As further shown, the overhead storage compartments (162) and (172) do not extend into the aisle (102). Rather, the overhead storage compartments are relatively parallel to the respective row of seats with the width of each overhead storage compartment limited to the area above the seats.

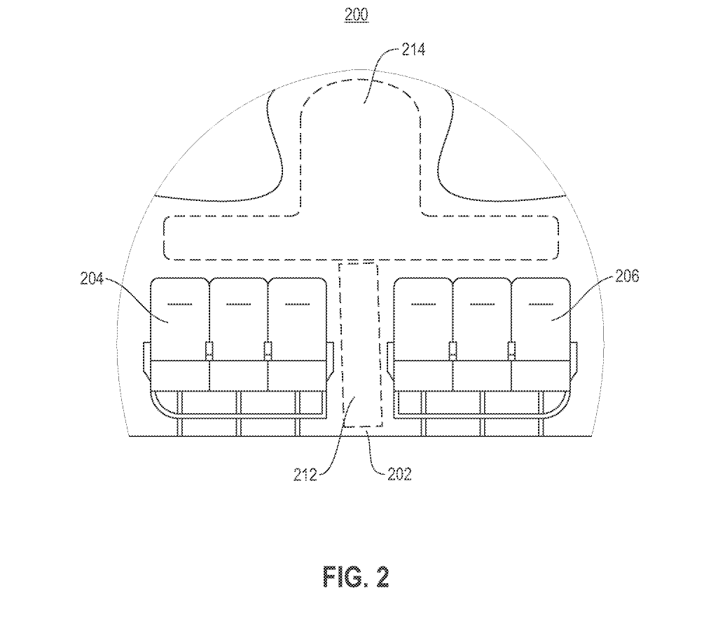

Referring to FIG. 2, a diagram (200) is provided illustrating useable space within an interior area of a commercial aircraft. As shown in FIG. 1, the aircraft depicted is a narrow bodied commercial aircraft with a single aisle (202) and two rows of seats (204) and (206) positioned on opposite sides of the aisle (202). Available space (212) is shown at the aisle (202). In addition, available space (214) is shown above both rows of seats (204) and (206), and extending across the aisle (202). The boundaries of the available space (214) are the top of the seats, the overhead compartments, and the ceiling of the interior of the aircraft. A cross section of the aircraft would demonstrate that the square inch opening of available space (212) is less than the size of the opening (214). In other words, there is more space available at (214) in the overhead area than at (212) between the two rows of seats.

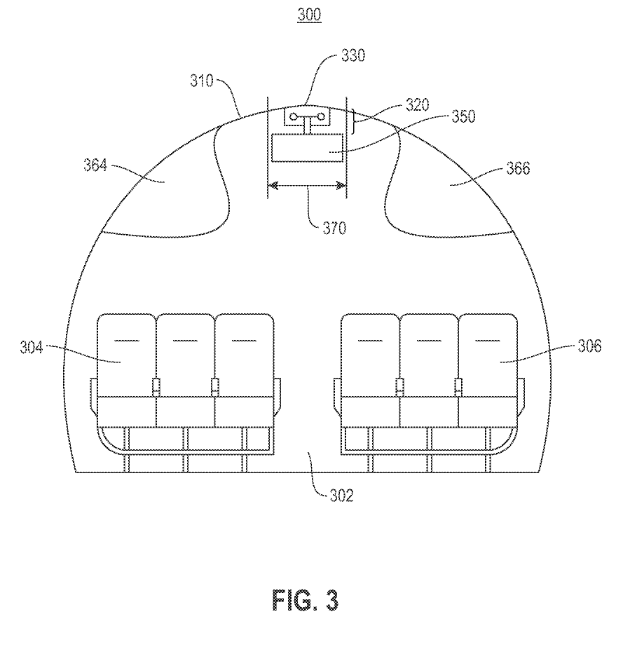

The overhead available space is relatively benign and is not utilized as a functional space in current aircraft design. Referring to FIG. 3, a diagram (300) is provided depicting a delivery mechanism in communication with the ceiling. More specifically, the diagram (300) is a cross sectional view of the interior of the aircraft. As shown in FIG. 1, the diagram includes two rows of seats (304) and (306), and an aisle (302) positioned between the two rows. At the same time, overhead storage is shown as (364) and (366), with storage (364) positioned relatively to row (304) and storage (366) positioned relative to row (306). A delivery system (320) is mounted to the ceiling (310), and a storage compartment (350) is shown positioned relative to the ceiling (310). As shown, in one embodiment, the size of the storage compartment (350) is within the width (370) of the aisle (302). Similarly, in one embodiment, the storage compartment (350) may be sized wider than the aisle, while an extension of the compartment orthogonal to the rail axis may be limited to an area above the seats position in the fuselage. The delivery system (320) includes a load bearing rail structure (330), hereinafter referred to as a rail (330). The storage compartment (350) is configured to travel along the transport apparatus (320) via the rail (330).

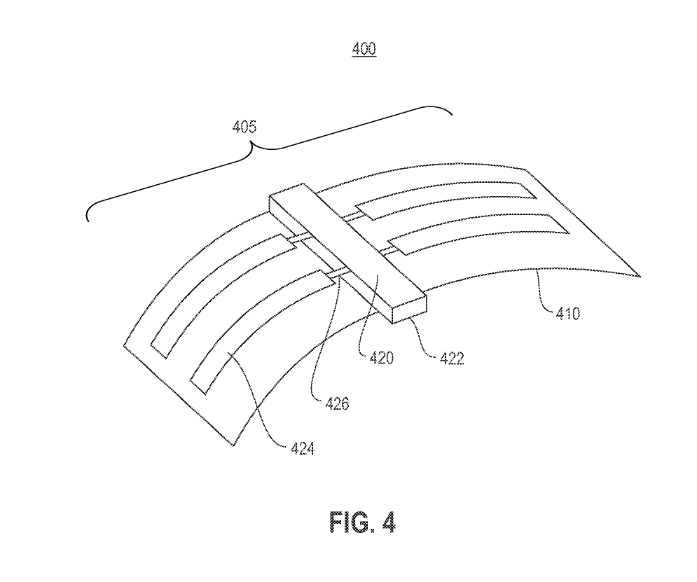

Referring to FIG. 4, a diagram (400) is provided depicting the structure of a delivery system (405) extending through the aircraft interior. As shown, the aircraft has an overhead surface, hereinafter referred to as a ceiling (410), that extends the length and width of the aircraft. In one embodiment, the delivery system (405) is mounted to the ceiling (410). A rail (420) of the delivery system (405) is shown extending through the length of the aircraft and in communication with the ceiling (410). More specifically, the rail (420) has two sections, including a primary section (422) and a secondary section (424). The primary section (422) is the portion of the rail (420) extending lengthwise through the fuselage. The secondary section (424) is shown extending across the width of the aircraft at select locations. Similar to the primary section (422), the secondary section (424) is in communication with the ceiling (410). In one embodiment, a joint (426) is shown at an intersection of the primary section (422) and the secondary section (424). As shown, in one embodiment, the joint (426) has curvature in its profile to connect the primary and secondary sections (422) and (424), respectively.

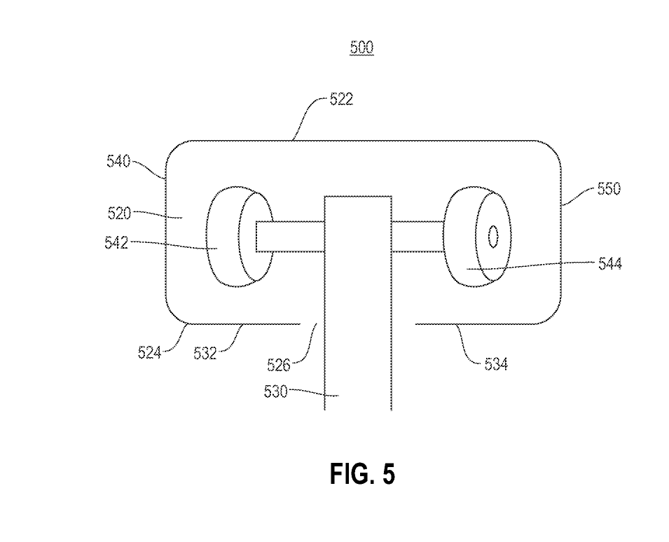

The delivery system shown and described in FIG. 4 is a single rail delivery system. Referring to FIG. 5, a cross-section (500) of the delivery system of FIG. 4 is shown. The delivery system is configured with a frame (520). The frame has a first wall (522) and second wall (524). The first wall (522) has a planar, or relatively planar, profile and is configured to be mounted to the ceiling of the aircraft interior. The second wall (524) is positioned opposite the first wall (522) and also has a planar or relatively planar profile. The second wall (524) has an opening (526) configured to receive a connector (530). The opening (526) divides the second wall into two sections referred to as first section (532) and second section (534). The frame (520) includes a set of secondary walls (540) and (550), also referred to herein as side walls, which function to enclose the frame (520). The secondary walls (540) and (550) are relatively parallel with mirror image configurations. A set of wheels are shown positioned in the frame (520), including a first wheel (542) and a second wheel (544). The first wheel (542) is shown in communication with the first section (532) and the second wheel (544) is shown in communication with the second section (534). The connector (530) is shown between the wheels (542) and (544), and positioned in the opening (526). The connector (530) functions as an interface between the rail (510) and a storage compartment (not shown). Details of the connector and associated storage compartment(s) are described below.

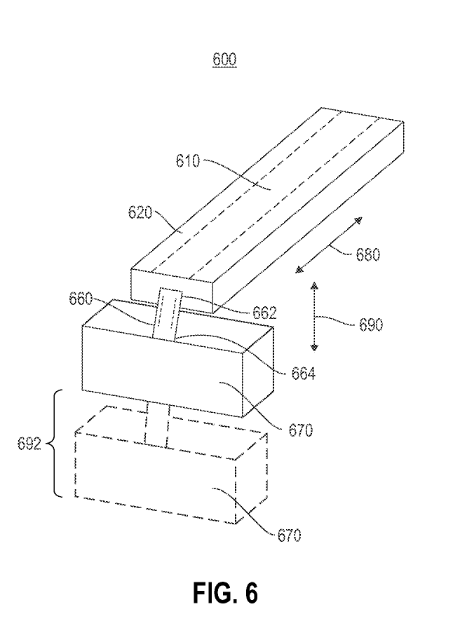

Referring to FIG. 6, a perspective view (600) of the delivery system of FIG. 4 is shown. A rail (610) is shown with a frame (620). A connector (660) is shown having a proximal end (662) and a distal end (664). The proximal end (662) is in communication with the rail (610), as shown and described in FIG. 5. The distal end (664) is in communication with a storage compartment (670). The configuration of the rail (610) in combination with the connector (660) supports and enables movement of the storage compartment in at least two separate axes (680) and (690). The axes and the components that move along the axes have an orthogonal relationship, such that the second axis is orthogonal to the first axis and the compartment (670) mounted on the rail (610). The first axis (680) pertains to the rail and movement of the compartment (670) along the rail, including movement relative to the aisle, formed by the seating arrangement, on the primary section of the rail, and movement on the secondary section of the rail. The connector (660) is configured as a telescopic attachment and enables extension and retraction along a second axis (690) perpendicular to the first axis (680). In one embodiment, the telescopic attachment may include a plurality of concentric sections designed to slide into one another. The compartment (670) is shown herein in a retracted position. In one embodiment, the retracted position is the transport position for the compartment to be transported along the rail (610), and the extended position (692) is a serving position for access to an interior section of the compartment (672). The telescopic attachment enables the compartment to be effectively lowered to a position where placing items within the compartment or taking items out of the compartment will happen at a vertical position that is at or about a waist level of an attendant, thereby making access to the compartment ergonomically friendly.

It is understood that movement of the compartment (670) along the two axes is bilateral. In other words, the movement of the compartment (670) along the first axis (680) is bi-directional, and movement of the compartment along the second axis (690) is bi-directional. At the same time, the compartment may be temporarily prohibited from movement along one or both axes. For example, in a configuration where movement is enabled along the first axis (680), movement may be disabled along the second axis (690). Similarly, in a configuration where movement is enabled along the second axis (690), movement may be disabled along the first axis (680). Different mechanisms may be employed for the movement restrictions, such as, but not limited to a brake mechanism along the first axis (680), or a stop configured within one or more concentric sections of the connector (660). In one embodiment, different mechanisms and components may be employed to restrict and/or enable movement along the axes. Furthermore, in one embodiment, movement of the compartment along the first axis (680) may be restricted at such time as the compartment is subject to movement along the second axis (690), and movement along the second axis (690) may be restricted at such time as the compartment is subject to movement along the first axis (680).

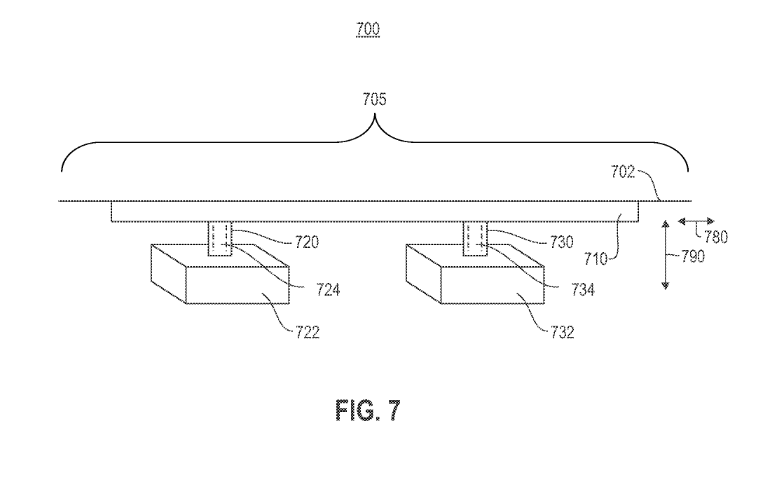

Referring to FIG. 7, a diagram (700) is provided illustrating stacking of multiple storage compartments along a delivery system. For descriptive purposes, the delivery system (705) is shown with a single rail (710) mounted to a surface (702). Multiple connectors (720) and (730) are provided mounted on the rail (710). Although only two connectors are shown, in one embodiment, additional connectors may be provided in communication with the rail (710). Each connector has an associated storage compartment. Namely, connector (720) has compartment (722) and connector (730) has compartment (732). Each compartment is in communication with the associated connector via a separate telescopic attachment. Namely, connector (720) employs telescopic attachment (724) as an interface with compartment (722), and connector (730) employs telescopic attachment (734) as an interface with compartment (732). Each telescopic attachment (724) and (734) is configured with multiple concentric elements to enable projection of the compartment along the second axis (790) orthogonal to the first axis (780) pertaining to directional movement along the rails. Furthermore and as shown, each connector (720) and (730) is sized with respect to the associated compartment (722) and (732), respectively, so that there is no interference between adjacently positioned compartments, thereby enabling projection of movement of either compartment (722) and (732) along the second axis (790).

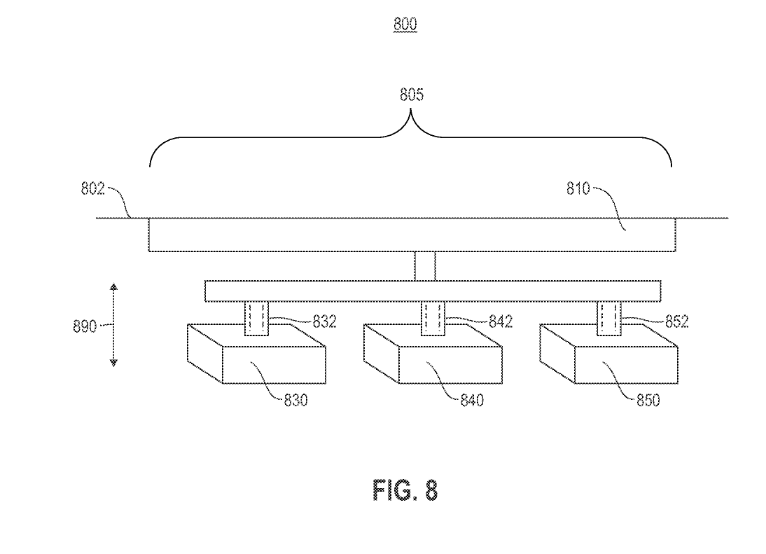

Referring to FIG. 8, a diagram (800) is provided illustrating stacking of multiple storage compartments along a rail mounted transport system. For descriptive purposes, the delivery system (805) is shown with a single rail (810) mounted to a surface (802). A single connector (820) is shown mounted on the rail (810). Although, in one embodiment, multiple connectors similarly configured may be mounted to the rail (810), or a mix of connectors with the mounting shown herein or the mount shown in FIG. 7 may be mounted to the rail (810). The connector (820) is shown herein with multiple compartments in communication with a single connector (820), and in this example there are three compartments (830), (840), and (850), although the quantity should not be considered limiting. Each compartment has an associated mount. Namely, compartment (830) has mount (832), compartment (840) has mount (842), and compartment (850) has mount (852), with each mount functioning as an interface between the compartment and the connector (820). Similarly to the configuration shown and described in FIG. 7, each mounts is a separate telescopic attachment and each mount may be independent extended or retracted with respect to the connector (820). Furthermore and as shown, each compartment (830), (840), and (850) is sized and positioned so that there is no interference between adjacently positions compartments, thereby enabling projection of movement of the compartment along the second axis (890).

With respect to FIG. 7 and as described in FIG. 8, multiple connectors may be mounted to the rail. Each mounted compartment is independently connected to the rail system shown herein, also referred to herein as segmented containers. This segmentation provides ease of storage and re-load before or during service. In one embodiment, one of the compartments inventory may become low during distribution of product. This compartment may be detached from the rail system and replaced with a new compartment that may be attached to the rail system in place of the detached compartment. Similarly, in one embodiment, one or more compartments may be utilized to gathered trash from the seating area of the fuselage. Such compartments may have their respective mounting in an extended position, so that the trash may be placed directly into the container. At such time as the compartment may become full with trash, the compartment may be detached from the rail mount. Accordingly, the segmented compartments together with the rail mount provide ease of use and flexibility to both distribution of product and gathering of trash after product use is complete.

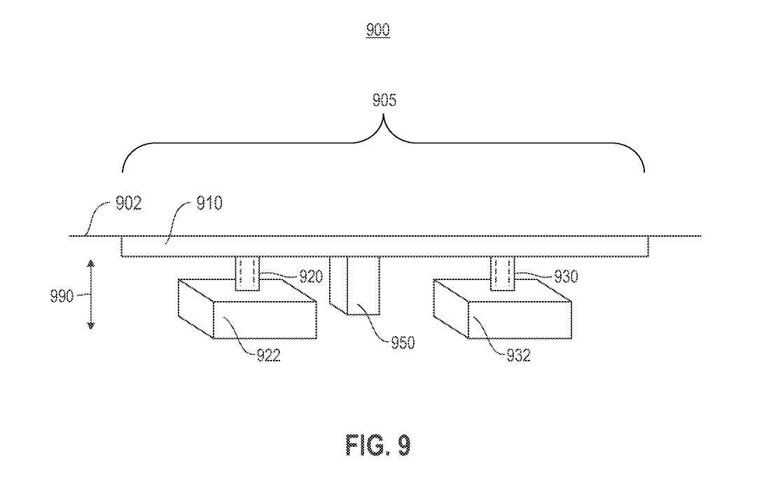

In one embodiment, the connectors and compartments are sized to eliminate or mitigate interference between adjacently positioned connectors and associated compartments. Similarly, in one embodiment, a secondary mechanism may be employed to mitigate interference. Referring to FIG. 9, a diagram (900) is provided illustrating mounting of multiple connectors to a rail (910) of a delivery system (905). As shown, the rail (910) is mounted to a surface (902), and multiple connectors are provided in communication with the rail (910), namely connector (920) and (930). Each connector has a compartment in communication with the connector via an attachment. Namely, compartment (922) is associated with connector (920) and compartment (932) is associated with connector (930). A buffer (950) is shown mounted to the rail (910) and positioned between connector (920) and connector (930). The buffer functions to mitigate interference between the associated compartments, namely to enable freedom of movement of each compartment along the second axis (990), even when the compartments are adjacently positioned.

The embodiments shown and described in FIGS. 1-9 illustrate different physical configurations for rail mounting of compartments on a ceiling of an aircraft. One or more storage compartments are in communication with a ceiling mounted rail system. Through the telescopic extension, each compartment may be subject to movement along the orthogonal axis, e.g. orthogonal to the rail. In one embodiment, the length of the extension for the compartment is restricted by the height of the chair(s) positioned on either side of the aisle. At the same time, the rail mount is shown to have two rail sections, one section parallel with the aisle, and a second section substantially perpendicular to the aisle. In one embodiment, the second section is positioned between seating sections in the craft. Similarly, in one embodiment, the extension of the compartment when positioned along the second rail mount section is less than the extension of the compartment when positioned along the first rail mount section. Accordingly, the range of the telescopic extension length may be subject to change when the compartment is positioned along different sections of the rail.

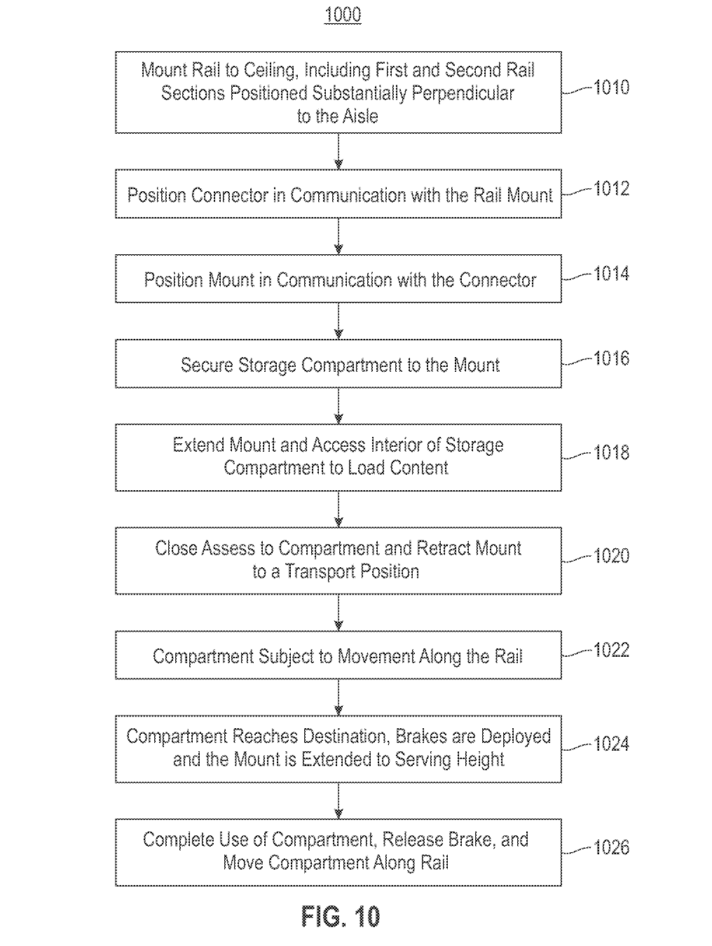

Referring to FIG. 10, a flow chart (1000) is provided illustrating a process for utilizing the rail mount storage compartment(s). As shown, a rail mount is mounted to the ceiling of an aircraft, and separated into two sections, with a first rail mount section parallel to the aisle and a second rail mount section perpendicular or substantially perpendicular to the aisle (1010). A connector is positioned in communication with the rail mount, and as shown herein positioned in the second rail mount section (1012). A mount is provided in communication with the connector (1014), and a storage compartment is attached or otherwise secured to the mount (1016). In one embodiment, the storage compartment is telescopically extended in a vertical direction to allow an attendant to open the compartment and place food and/or beverages into the compartment (1018). When the compartment has been loaded, the compartment is closed and telescopically retracted to a transport position (1020). In one embodiment, the connector has a brake or braking system that is enabled when the compartment is in an extended position. When in the transport position, the connector may move the compartment from the first rail section to the second rail section (1022). The compartment may be further moved along the first rail section to an area within the craft where the compartment is designated to be dispensed. At such time as the compartment has reached its destination, an attendant may deploy the brake(s), and extend the compartment to a serving height (1024). In one embodiment, the extension of the compartment provided an ergonomic benefit for the attendant in that the compartment may be adjusted along the orthogonal axis so that the height of the compartment is set to the proper height for the attendant to utilize the compartment. At such time as the compartment is empty or the dispensing is completed, the compartment is retracted along the orthogonal axis to a transport position and the brake(s) is released to enable movement of the compartment along the first rail mount section (1026). Accordingly, the process shown and described herein takes advantage of empty space along the ceiling of the craft and further opens space along the aisle.

Furthermore, the described features, structures, or characteristics may be combined in any suitable manner in one or more embodiments. In the following description, numerous specific details are provided, such as examples of compartments, mounts, and rail sections, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Aspects of the present invention are described herein with reference to a flowchart illustration and/or block diagrams of methods, and apparatus (systems) according to embodiments of the invention. It will be understood that each block of the flowchart illustrations and/or block diagrams, and combinations of blocks in the flowchart illustrations and/or block diagrams, can be implemented.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented to perform the specified functions or acts or carry out combinations of the supported functions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the implementation of rail mount system addresses transport of items within an aircraft while mitigating interference along the aisle.

It will be appreciated that, although specific embodiments of the invention have been described herein for purposes of illustration, various modifications may be made without departing from the spirit and scope of the invention. In particular, the embodiments have been described herein with respect to an aircraft. In one embodiment, the overhead delivery system may be incorporated into another travel craft in which there is space available in the ceiling area, and/or in another travel craft in which there is a need or desire to maintain space along a walkway or aisle or to otherwise take advantage of and utilize available space. For example, the overhead delivery system may be incorporated into a train, or other forms of land vehicles. In one embodiment, the interior of a train car may include an aisle with two rows of seats on either side of the aisle, and a ceiling. There may be available space at the aisle and above the rows of seats. The overhead delivery system may be mounted to the ceiling, such as in accordance with the embodiments described above in the context of an aircraft. Similarly, the compartment has been described to be telescopically mounted to a rail connector of the overhead delivery system. In one embodiment, an alternative mount may be provided, with the mount enabling movement of the compartment along the orthogonal axis, as described herein.

Furthermore, the embodiments described herein may be incorporated into any region or venue having a surface capable of supporting the mounted overhead delivery system as described above and/or any region or venue in which there is a need or desire to maintain space along a walkway or aisle or to otherwise take advantage of and utilize available space. Examples of such regions or venues may include, but are not limited to, theaters, cafeterias, classrooms, restaurants, cinemas, etc. Accordingly, the scope of protection of this invention is limited only by the following claims and their equivalents.

We claim:

1. A system comprising:
a delivery system mounted to an overhead surface of a region, the delivery system comprising a primary section and a secondary section, wherein the primary section extends through a length of the region from a front end of the surface to a back end of the surface, and wherein the secondary section extends relatively perpendicular to the primary section; and
at least one container in communication with the delivery system, wherein the at least one container is subject to movement along at least first and second axes, wherein the first axis is parallel with the primary and secondary sections, and the second axis is orthogonal to the first axis and the delivery system, and wherein the at least one container is configured to transport a product for delivery to a destination via the at least first and second axes.

2. The system of claim 1, wherein the region is an interior of a fuselage, the interior of the fuselage further comprising a seating area positioned on a surface opposite to the overhead surface, the seating area comprising at least a first set of seats, and wherein the delivery system is mounted to the overhead surface to provide a vertical clearance between the first set of seats and the at least one container.

3. The system of claim 1, further comprising at least one connector in communication with the delivery system and the at least one container, including an attachment device secured from the container to the connector to subject the connector to movement along the second axis, wherein each connector is configured to be an interface between the delivery system and a respective container.

4. The system of claim 3, further comprising a vertical arrangement of at least first and second containers along the second axis, including at least two containers arranged in communication with the at least one connector, where in the first and second containers are independently subject to movement along the second axis.

5. The system of claim 1, further comprising a first container positioned in communication with the delivery system, a second container positioned in communication with the delivery system adjacent to the first container, and a first buffer positioned between the first and second containers, wherein the first buffer functions as a first gap in the first axis between the first and second containers.

6. The system of claim 1, wherein the movement along the second axis comprises a retracted position and an expanded position.

7. The system of claim 3, further comprising a first connector configured to receive a first container and a second container positioned relative to the first container along the second axis, wherein the first connector is configured to support changing a profile of the positioned first and second containers along the second axis, including a change of a stacked arrangement of the containers.

8. The system of claim 7, further comprising a second connector in communication with the delivery system and adjacent to the first connector, and a second buffer to function as a second gap along the first axis between the first and second connectors, wherein the second gap maintains the first gap and prevents an intersection of the first and second container along the first axis.

9. The system of claim 1, further comprising a brake in communication with the delivery system, including a first brake position to hold the container in a substantially stationary position and a second brake position to allow movement of the container along the delivery system.

10. A method comprising:
mounting a delivery system to an overhead surface of a region, the delivery system comprising a primary section and a secondary section, wherein the primary section extends through a length of the region from a front end of the surface to a back end of the surface, and wherein the secondary section extends relative perpendicular to the primary section;
configuring at least one container in communication with the delivery system to be subject to movement along at least first and second axes, wherein the first axis is parallel with the primary and secondary sections, and the second axis is orthogonal to the first axis and the delivery device; and
transporting a product within the at least one container for delivery to a destination via the at least first and second axes.

11. The method of claim 10, further comprising placing at least one connector in communication with the delivery system and the at least one container, wherein each connector is configured to be an interface between the delivery system and a respective container.

12. The method of claim 11, further comprising securing an attachment device from the container to the connector, and subjecting the connector to movement along the second axis.

13. The method of claim 12, further comprising vertically arranging at least first and second containers along the second axis, including arranging the first and second connectors in communication with the at least one connector, and independently subjecting the first and second containers to movement along the second axis.

14. The method of claim 10, wherein the movement along the second axis comprises a retracted position and an expanded position in relation to the connector.

15. The method of claim 10, further comprising positioning a first container in communication with the delivery system, and a second container in communication with the delivery system adjacent to the first container, and positioning a first buffer between the first and second containers, wherein the first buffer functions as a first gap in the first axis between the first and second containers.

16. The method of claim 11, further comprising positioning a first container in communication with a first connector and a second container relative to the first container along the second axis.

17. The method of claim 16, wherein the first connector is configured to support changing a profile of the positioned containers along the second axis, including changing a stacked arrangement of the containers.

18. The method of claim 16, further comprising positioning a second connector in communication with the delivery system and adjacent to the first connector, and a second buffer functioning as a second gap along the first axis between the first and second connectors.

19. The method of claim 18, wherein the second gap maintains the first gap and prevents intersection of the first and second containers along the first axis.

20. The method of claim 10, wherein the delivery system is in communication with a brake, and wherein the brake includes a first brake position holding the container in a substantially stationary position and a second brake position allowing movement of the container along the delivery system.
